(19) United States
(12) Patent Application Publication
(10) Pub. No.: US 2009/0186250 A1
(43) Pub. Date: Jul. 23, 2009

(54) Bilayer interconnects for solid oxide fuel cells

(75) Inventors: Yeshwanth Narendar, Westford, MA (US); Aravind Mohanram, Shrewsbury, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Saint-Gobain Ceramics & Plastics, Inc., Worcester, MA (US)

(21) Appl. No.: 12/005,656

(22) Filed: Dec. 27, 2007

Related U.S. Application Data
(60) Provisional application No. 60/877,502, filed on Dec. 28, 2006.

(51) Int. Cl. H01M 8/10; H01M 8/00

(52) U.S. Cl. 429/33; 429/30; 29/623.1

(57) ABSTRACT

A solid oxide fuel cell (SOFC) includes a plurality of sub-cells. Each sub-cell includes a first electrode in fluid communication with a source of oxygen gas, a second electrode in fluid communication with a source of a fuel gas, and a solid electrolyte between the first electrode and the second electrode. The SOFC further includes an interconnect between the sub-cells. The interconnect includes a first layer in contact with the first electrode of each sub-cell, and a second layer in contact with the second electrode of each sub-cell. The first layer includes at least one material selected from the group consisting of a doped M-ferrite based perovskite, a doped M′-ferrite based perovskite, a doped MM′-ferrite based perovskite and a doped M′-chromite based perovskite, wherein M is an alkaline earth metal and M′ is a rare earth metal. The second layer includes a doped M″-titanate based perovskite, wherein M″ is an alkaline earth metal. A solid oxide fuel cell having a plurality of cells as described above is formed by connecting each of a plurality of sub-cells with an interconnect as described above.

### RELATED APPLICATION

This application claims the benefit of U.S. Provisional Application No. 60/877,502, filed Dec. 28, 2006, the entire teachings of which are incorporated herein by reference.

### BACKGROUND

A fuel cell is a device that generates electricity by a chemical reaction. Among various fuel cells, solid oxide fuel cells use a hard, ceramic compound of metal (e.g., calcium or zirconium) oxide as an electrolyte. Typically, in solid oxide fuel cells, an oxygen gas, such as O₂, is reduced to oxygen ions (O²⁻) at the cathode, and a fuel gas, such as H₂ gas, is oxidized with the oxygen ions to from water at the anode.

Interconnects are one of the critical issues limiting commercialization of solid oxide fuel cells. Currently, most companies and researchers working with planar cells are using coated metal interconnects. While metal interconnects are relatively easy to fabricate and process, they generally suffer from high power degradation rates (e.g. 10%/1,000 h) partly due to formation of metal oxides, such as Cr₂O₃, at an interconnect-anode/cathode interface during operation. Ceramic interconnects based on lanthanum chromites (LaCrO₃) have lower degradation rates than metal interconnects partly due to relatively high thermodynamic stability and low Cr vapor pressure of LaCrO₃ compared to Cr₂O₃ formed on interfaces of the metal interconnects and electrode. However, doped LaCrO₃ generally suffers from dimensional changes, such as warping or some other form of distortion, and consequent seal failures under reducing conditions. Another issue related to LaCrO₃ is its relatively low sinterability.

Therefore, there is a need for development of new interconnects for solid oxide fuel cells, addressing one or more of the aforementioned problems.

### SUMMARY OF THE INVENTION

The invention is directed to a solid oxide fuel cell (SOFC) that includes a plurality of sub-cells and to a method of preparing the SOFC. Each sub-cell includes a first electrode in fluid communication with a source of oxygen gas, a second electrode in fluid communication with a source of a fuel gas, and a solid electrolyte between the first electrode and the second electrode. The SOFC further includes an interconnect between the sub-cells. The interconnect includes a first layer in contact with the first electrode of each cell, and a second layer in contact with the second electrode of each sub-cell. The first layer includes at least one material selected from the group consisting of a doped M-ferrite based perovskite, a doped M′-ferrite based perovskite, a doped MM′-ferrite based perovskite and a doped M′-chromite based perovskite, wherein M is an alkaline earth metal and M′ is a rare earth metal. The second layer includes a doped M″-titanate based perovskite, wherein M″ is an alkaline earth metal.

The invention also includes a method of forming a solid oxide fuel cell described above. The method includes connecting each of the sub-cells with an interconnect described above.

Without being bound to a particular theory, it is believed that, in the invention, the first layer in contact with the first electrode is exposed to less severe reducing conditions than the second layer in contact with the second electrode. Further, with respect to one embodiment of the invention, wherein the first layer includes an M-ferrite, M′-ferrite, MM′-ferrite or M′-chromite, such as Sr-doped LaFeO₃, it is believed that sinterability, stability and/or conductivity is improved relative to that of SOFCs employing a conventional monolayer of LaCrO₃. In addition, an M″-titanate, such as n-doped SrTiO₃ or CaTiO₃, included in the second layer of the interconnect of an embodiment of the invention is believed to exhibit less oxygen vacancy formation during operation of SOFCs, as compared to conventional p-doped LaCrO₃, thereby limiting or eliminating lattice expansion problems associated with conventional p-doped LaCrO₃.

### BRIEF DESCRIPTION OF THE DRAWINGS

FIG. 1 is a schematic cross-sectional view of one embodiment of the invention.

FIG. 2 is a schematic diagram of one embodiment of a fuel cell of the invention having a planar, stacked design.

FIG. 3 is a schematic diagram of one embodiment of a fuel cell of the invention having a tubular design.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawing is not necessarily to scale, emphasis instead being placed upon illustrating embodiments of the present invention.

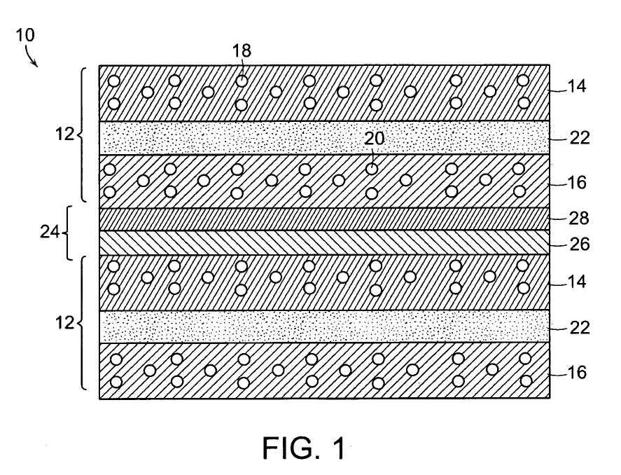

FIG. 1 shows fuel cell 10 of the invention. Fuel cell 10 includes a plurality of sub-cells 12. Each sub-cell 12 includes first electrode 14 and second electrode 16. Typically, first and second electrodes 14 and 16 are porous. In fuel cell 10, first electrode 14 at least in part defines a plurality of first gas channels 18 in fluid communication with a source of oxygen gas, such as air. Second electrode 16 at least in part defines a plurality of second gas channels 20 in fluid communication with a fuel gas source, such as H₂ gas or a natural gas which can be converted into H₂ in situ at second electrode 16.

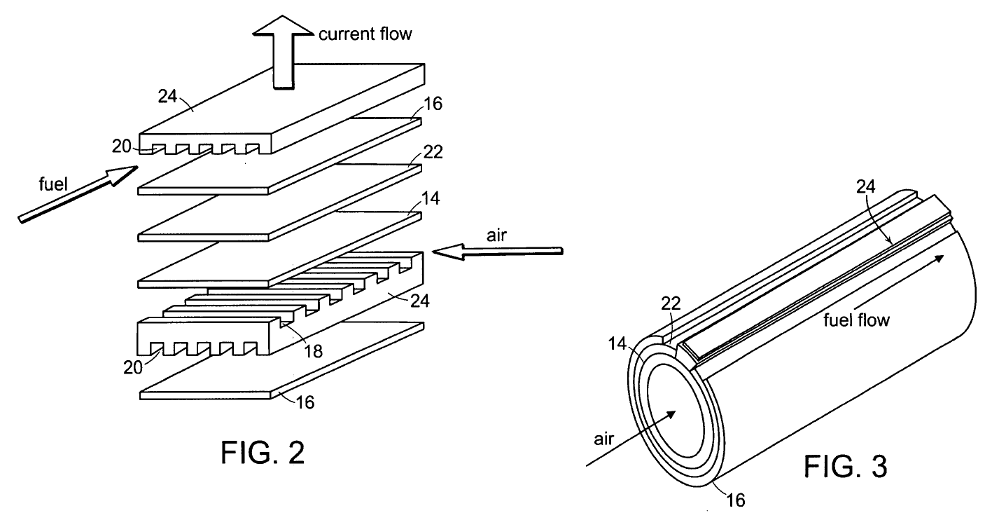

Although, in FIG. 1, first electrodes 14 and second electrodes 16 define a plurality of gas channels 18 and 20, other types of gas channels, such as a microstructured channel (e.g, grooved channel) at each of the electrodes or as a separate layer in fluid communication with the electrode, can also be used in the invention. For example, referring to FIG. 2, first gas channel 18 is defined at least in part by first electrode 14 and by at least in part by interconnect 24, and second gas channel 20 is defined at least in part by second electrode 16 and by at least in part by interconnect 24.

Any suitable cathode materials known in the art can be used for first electrode 14, for example, in “High Temperature Solid Oxide Fuel Cells: Fundamentals, Design and Applications,” pp. 119-143, Dinghal, et al. Ed., Elsevier Ltd. (2003), the entire teachings of which are incorporated herein by reference. In one embodiment, first electrode 14 includes a La-manganate (e.g, La₁₋ₐMnO₃, where a is equal to or greater than zero, and equal to or less than 0.1) or La-ferrite based material. Typically, the La-manganate or La-ferrite based material is doped with one or more suitable dopants, such as Sr, Ca, Ba, Mg, Ni, Co or Fe. Examples of doped La-manganate based materials include LaSr-manganates (LSM) (e.g., La₁₋ₖSrₖMnO₃, where k is equal to or greater than 0.1, and equal to or less than 0.3, (La+Sr)/Mn is in a range of between about 1.0 and about 0.95 (molar ratio)) and LaCa-manganates (e.g., La₁₋ₖCaₖMnO₃, k is equal to or greater than 0.1, and equal to or less than 0.3, (La+Ca)/Mn is in a range of between about 1.0 and about 0.95 (molar ratio)). Examples of doped La-ferrite based materials include LaSrCo-ferrite (LSCF) (e.g. La_{1-q}Sr_{q}Co₁₋ⱼFeⱼO₃, where each of q and j independently is equal to or greater than 0.1, and equal to or less than 0.4, (La+Sr)/(Fe+Co) is in a range of between about 1.0 and about 0.95 (molar ratio)). In one specific embodiment, first electrode 14 includes at least one of a LaSr-manganate (LSM) (e.g., La₁₋ₖSrₖMnO₃) and a LaSrCo-ferrite (LSCF). Common examples include (La_{0.8}Sr_{0.2})_{0.98}MnO_{3±δ} (δ is equal to or greater than zero, and equal to or less than 0.3) and La_{0.6}Sr_{0.4}Co_{0.2}Fe_{0.8}O₃.

Any suitable anode materials known in the art can be used for second electrode 16, for example, in “High Temperature Solid Oxide Fuel Cells: Fundamentals, Design and Applications,” pp. 149-169, Dinghal, et al. Ed., Elsevier Ltd. (2003), the entire teachings of which are incorporated herein by reference. In one embodiment, second electrode 16 includes a nickel (Ni) cermet. As used herein, the phrase “Ni cermet” means a ceramic metal composite that includes Ni, such as about 20 wt %-70 wt % of Ni. Examples of Ni cermets are materials that include Ni and yttria-stabilized zirconia (YSZ), such as ZrO₂ containing about 15 wt % of Y₂O₃, and materials that include Ni and Y-zirconia or Sc-zirconia. An additional example of an anode material is Cu-cerium oxide. A specific example of an Ni cermet includes 67 wt % Ni and 33 wt % YSZ.

Typically, the thickness of each of first and second electrodes 14 and 16 is independently is in a range of between about 0.5 mm and about 2 mm. Specifically, the thickness of each of first and second electrodes 14 and 16 is, independently, in a range of between about 1 mm and about 2 mm.

Solid electrolyte 22 is between first electrode 14 and second electrode 16. Any suitable solid electrolytes known in the art can be used in the invention such as those described in “High Temperature Solid Oxide Fuel Cells: Fundamentals, Design and Applications,” pp. 83-112, Dinghal, et al. Ed., Elsevier Ltd. (2003), the entire teachings of which are incorporated herein by reference. Examples include ZrO₂ based materials, such as Sc₂O₃-doped ZrO₂, Y₂O₃-doped ZrO₂, and Yb₂O₃-doped ZrO₂; CeO₂ based materials, such as Sm₂O₃-doped CeO₂, Gd₂O₃-doped CeO₂, Y₂O₃-doped CeO₂ and CaO-doped CeO₂; Ln-gallate based materials (Ln=a lanthanide, such as La, Pr, Nd or Sm), such as LaGaO₃ doped with Ca, Sr, Ba, Mg, Co, Ni, Fe or a mixture thereof (e.g., LaO_{0.8}Sr_{0.2}Ga_{0.8}Mg_{0.2}O₃, La_{0.8}Sr_{0.2}Ga_{0.8}Mg_{0.15}Co_{0.05}O₃, La_{0.9}Sr_{0.1}Ga_{0.8}Mg_{0.2}O₃, LaSrGaO₄, LaSrGa₃O₇ or La_{0.9}A_{0.1}Ga₃ where A=Sr, Ca or Ba); and mixtures thereof. Other examples include doped yttrium-zirconate (e.g., YZr₂O₇), doped gadolinium-titanate (e.g., Gd₂Ti₂O₇) and brownmillerites (e.g., Ba₂In₂O₆ or Ba₂In₂O₅). In a specific embodiment, electrolyte 22 includes ZrO₂ doped with 8 mol % Y₂O₃ (i.e., 8 mol % Y₂O₃-doped ZrO₂.)

Typically, the thickness of solid electrolyte 22 is in a range of between about 5 μm and about 20 μm, such as between about 5 μm and about 10 μm. Alternatively, the thickness of solid electrolyte 22 is thicker than about 100 μm (e.g., between about 100 μm and about 500 100 μm). In this embodiment employing solid electrolyte 22 having a thickness greater than about 100 μm, solid electrolyte 22 can provide structural support for fuel cell 10.

Fuel cell 10 further includes interconnect 24 between cells 12. Interconnect 24 includes first layer 26 in contact with first electrode 14, and second layer 28 in contact with second electrode 16. First layer 26 includes at least one material selected from the group consisting of a doped M-ferrite based perovskite, a doped M′-ferrite based perovskite, a doped MM′-ferrite based perovskite and a doped M′-chromite based perovskite, wherein M is an alkaline earth metal and M′ is a rare earth metal. Second layer 28 includes a doped M″-titanate based perovskite, wherein M″ is an alkaline earth metal. Preferably, the material included in first layer 26 is p-doped, and the material included in second layer 28 is n-doped. Suitable p-dopants include Sr, Ca, Mg, Ni, Co, V and Ti. Suitable n-dopants include La, Y, Nb, Mn, V, Cr, W, Mo and Si.

In one embodiment, each of M and M″ is independently Sr, Ba, Ca or Mg. In another embodiment, M′ is La or Y. In a specific embodiment, M is Sr or Ba, M′ is La or Y, and M″ is Sr, Ca, Ba or Mg.

In a more specific embodiment, first layer 26 includes a La-ferrite, Sr-ferrite, LaSr-ferrite, Ba-ferrite, Y-chromite or La-chromite that is doped with at least one dopant selected from the group consisting of Sr, Ca, Mg, Ni, Co, V and Ti.

In another more specific embodiment, second layer 28 includes at least one of n-doped Sr-titanate, n-doped Ca-titanate, n-doped Ba-titanate and n-doped Mg-titanate. Preferably, second layer 28 includes a Sr-titanate or Ca-titanate that is doped with at least one dopant selected from the group consisting of La, Y, Nb, Mn, V, Cr, W, Mo and Si.

As used herein, “perovskite” has the perovskite structure known in the art, for example, in “High Temperature Solid Oxide Fuel Cells: Fundamentals, Design and Applications,” pp. 120-123, Dinghal, et al. Ed., Elsevier Ltd. (2003), the entire teachings of which are incorporated herein by reference. The perovskite structure is adopted by many oxides that have the chemical formula of ABO₃. The general crystal structure is a primitive cube with the A-cation in the center of a unit cell, the B-cation at the comers of the unit cell, and the anion (i.e., O²⁻) at the centers of each edge of the unit cell. The idealized structure is a primitive cube, but differences in ratio between the A and B cations can cause a number of different so-called distortions, of which tilting is the most common one. As used herein, the phrases “M-ferrite based perovskite,” “M′-ferrite based perovskite,” “MM′-ferrite based perovskite M,” “M′-chromite based perovskite,” and “M″-titanate based perovskite” each independently also include such distortions. Generally, in the “M-ferrite based perovskite,” “M′-ferrite based perovskite,” “MM′-ferrite based perovskite M,” “M′-chromite based perovskite,” and “M″-titanate based perovskite,” M, M′ and M″ atoms each independently occupy the A-cation sites, while Fe atoms in ferrite, Cr atoms in chromite and Ti in titanate independently occupy the B-cation sites.

Typically, the thickness of each of first layer 26 and second layer 28 is in a range of between about 5 μm and about 1000 μm. Specifically, the thickness of each of first layer 26 and second layer 28 is in a range of between about 10 μm and about 1000 μm.

Interconnect 24 can be in any shape, such as a planar shape (see FIG. 1) or microstructured (e.g., grooved) shape (see FIG. 2). In one specific embodiment, at least one interconnect 24 of fuel cell 10 is substantially planar.

In one embodiment, the thickness of interconnect 24 is in a range of between about 10 μm and about 1,000 μm. Alternatively, the thickness of interconnect 24 is in a range of between about 0.005 mm and about 2.0 mm. In one specific embodiment, the thickness of interconnect 24 is in a range of 10 μm and about 500 μm. In another embodiment, the thickness of interconnect 24 is in a range of 10 μm and about 200 μm. In yet another embodiment, the thickness of interconnect 24 is between about 10 μm and about 100 μm. In yet another embodiment, the thickness of interconnect 24 is between about 10 μm and about 75 μm. In yet another embodiment, the thickness of interconnect 24 is between about 15 μm and about 65 μm.

In one specific embodiment, first electrode 14 and/or second electrode 16 has a thickness of between about 0.5 mm and about 2 mm thick, more specifically between about 1 mm and about 2 mm thick; and interconnect 24 has a thickness of between about 10 μm and about 200 μm.

In yet another specific embodiment, first electrode 14 and/or second electrode 16 has a thickness of between about 0.5 mm and about 2 mm thick, more specifically between about 1 mm and about 2 mm thick; and interconnect 24 has a thickness of between about 10 μm and about 100 μm.

In yet another specific embodiment, at least one cell 12 includes porous first and second electrodes 14 and 16, each of which is between about 0.5 mm and about 2 mm thick, more specifically between about 1 mm and about 2 mm thick; solid electrolyte 22 has a thickness of between about 5 μm and about 20 μm; and interconnect 24 is substantially planar and has a thickness of between about 10 μm and about 200 μm.

In yet another specific embodiment, first electrode 14 includes (La_{0.8}Sr_{0.2})_{0.98}MnO_{3±δ} or La_{0.6}Sr_{0.4}Co_{0.2}Fe_{0.8}O₃; and second electrode 16 includes 67 wt % Ni and 33 wt % YSZ. In this embodiment, specifically, electrolyte 22 includes 8 mol % Y₂O₃-doped ZrO₂.

In yet another specific embodiment, interconnect 24 is substantially planar; and each of first and second electrodes 14 and 16 is porous; and first electrode 14 includes a La-manganate or La-ferrite based material (e.g., La₁₋ₖSrₖMnO₃ or La_{1-q}Sr_{q}CoⱼFe₁₋ⱼO₃, values of each of k, q and j independently are as described above), and second electrode 16 includes a Ni cermet (e.g., 67 wt % Ni and 33 wt % YSZ). In this embodiment, specifically, electrolyte 22 includes 8 mol % Y₂O₃-doped ZrO₂.

Fuel cell 10 of the invention can include any suitable number of a plurality of sub-cells 12. In one embodiment, fuel cell 10 of the invention includes at least 30-50 sub-cells 12. Sub-cells 12 of fuel cell 10 can be connected in series or in parallel.

A fuel cell of the invention can be a planar stacked fuel cell, as shown in FIG. 2. Alternatively, as shown in FIG. 3, a fuel cell of the invention can be a tubular fuel cell. Fuel cells shown in FIGS. 2 and 3 independently have the characteristics, including specific variables, as described for fuel cell 10 shown in FIG. 1 (for clarity, details of cell components are not depicted in FIGS. 2 and 3). Typically, in the planar design, as shown in FIG. 2, the components are assembled in flat stacks, with air and fuel flowing through channels built into the interconnect. Typically, in the tubular design, as shown in FIG. 3, the components are assembled in the form of a hollow tube, with the cell constructed in layers around a tubular cathode; air flows through the inside of the tube and fuel flows around the exterior.

The invention also includes a method of forming fuel cells as described above. The method includes forming a plurality of sub-cells 12 as described above, and connecting each sub-cell 12 with interconnect 24. Fabrication of sub-cells 12 and interconnect 24 can employ any suitable techniques known in the art, for example, in “High Temperature Solid Oxide Fuel Cells: Fundamentals, Design and Applications,” pp. 83-225, Dinghal, et al. Ed., Elsevier Ltd. (2003), the entire teachings of which are incorporated herein by reference. For example, planar stacked fuel cells of the invention can be fabricated by particulate processes or deposition processes. Tubular fuel cells of the invention can be fabricated by having the cell components in the form of thin layers on a porous cylindrical tube, such as calcia-stabilized zirconia.

Typically, a suitable particulate process, such as tape casting or tape calendering, involves compaction of powders, such as ceramic powders, into fuel cell components (e.g., electrodes, electrolytes and interconnects) and densification at elevated temperatures. For example, suitable powder materials for electrolytes, electrodes or interconnects of the invention, are made by solid state reaction of constituent oxides. Suitable high surface area powders can be precipitated from nitrate and other solutions as a gel product, which are dried, calcined and comminuted to give crystalline particles. The deposition processes can involve formation of cell components on a support by a suitable chemical or physical process. Examples of the deposition include chemical vapor deposition, plasma spraying and spray pyrolysis.

In one specific embodiment, interconnect 24 is prepared by laminating a first-layer material of interconnect 24, and a second-layer material of interconnect 24, side-by-side at a temperature in a range of between about 50° C. and about 80° C. with a loading of between about 5 and about 50 tons, and co-sintered to form interconnect layers having a high theoretical density (e.g., greater than about 90% theoretical density, or greater than about 95% theoretical density), to thereby form first layer 26 and second layer 28, respectively.

Alternatively, interconnect 24 is prepared by sequentially forming first layer 26 and then second layer 28 (or forming second layer 28 and then first layer 26).

In the invention, sub-cells 12 are connected via interconnect 24. In one embodiment, at least one of the electrodes of each sub-cell 12 is formed independently from interconnect 24. Formation of electrodes 14 and 16 of each sub-cell 12 can be done using any suitable method known in the art, as described above. In one specific embodiment: i) a second-layer material of interconnect 24 is disposed over second electrode 16 of a first sub-cell; ii) a first-layer material of interconnect 24 is disposed over the second-layer material; and iii) first electrode 14 of a second sub-cell is then disposed over the first-layer material of interconnect 24. In another specific embodiment: i) a first-layer material of interconnect 24 is disposed over first electrode 14 of a second sub-cell; ii) a second-layer material of interconnect 24 is disposed over the first-layer material of interconnect 24; and iii) second electrode 16 of a first sub-cell is disposed over the second-layer material. In these specific embodiments, sintering the first-layer and second-layer materials forms first layer 26 and second layer 28 of interconnect 24, respectively.

Alternatively, one or more electrodes of sub-cells 12 (e.g., electrode 14 or 16, or electrodes 14 and 16) are formed together with formation of interconnect 24. In one specific embodiment: i) a second-layer material of interconnect 24 is disposed over a second-electrode material of a first sub-cell; ii) a first-layer material of interconnect 24 is then disposed over the second-layer material; iii) a first-electrode material of a second sub-cell is disposed over the first-layer of interconnect 24, and iv) heating the materials such that the first-layer and second-layer materials of interconnect 24 form first layer 26 and second layer 28 of interconnect 24, respectively, and that the first-electrode and second-electrode materials form first electrode 14 and second electrode 16, respectively.

In another specific embodiment: i) a second-layer material of interconnect 24 is disposed over second electrode 16 of a first sub-cell; ii) a first-layer material of interconnect 24 is disposed over the second-layer material; iii) disposing a first-electrode material of a second sub-cell over the first-layer of interconnect 24; and iv) heating the materials such that the first-layer and second-layer materials of the interconnect form first layer 26 and second layer 28 of interconnect 24, respectively, and that the first-electrode material forms first electrode 14.

The SOFCs of the invention can be portable. Also, the SOFCs of the invention, can be employed as a source of electricity in homes, for example, to generate hot water.

### EQUIVALENT

While this invention has been particularly shown and described with references to example embodiments thereof, it will be understood by those skilled in the art that various changes in form and details may be made therein without departing from the scope of the invention encompassed by the appended claims.

What is claimed is:

1. A solid oxide fuel cell, comprising;
a) a plurality of sub-cells, each sub-cell including:
i) a first electrode in fluid communication with a source of oxygen gas;
ii) a second electrode in fluid communication with a source of a fuel gas; and
iii) a solid electrolyte between the first electrode and the second electrode; and
b) an interconnect between the sub-cells, the interconnect including:
i) a first layer of at least one material selected from the group consisting of a doped M-ferrite based perovskite, a doped M′-ferrite based perovskite, a doped MM′-ferrite based perovskite and a doped M′-chromite based perovskite, wherein M is an alkaline earth metal and M′ is a rare earth metal, and wherein the first layer is in contact with the first electrode of each sub-cell; and
ii) a second layer that includes a doped M″-titanate based perovskite, wherein M″ is an alkaline earth metal, and wherein the second layer is in contact with the second electrode of each sub-cell.

2. The solid oxide fuel cell of claim 1, wherein each sub-cell further includes a first gas channel in fluid communication with the oxygen gas source and with the first electrode, and a second gas channel in fluid communication with the fuel gas source and with the second electrode.

3. The solid oxide fuel cell of claim 2, wherein the first electrode at least in part defines the first gas channel, and the second electrode at least in part defines the second gas channel.

4. The solid oxide fuel cell of claim 1, wherein each of the first and second electrodes is porous.

5. The solid oxide fuel cell of claim 4, wherein the interconnect is substantially planar.

6. The solid oxide fuel cell of claim 1, wherein M is Sr, Ca, Ba or Mg; M′ is La or Y; and M″ is Sr, Ca, Ba or Mg.

7. The solid oxide fuel cell of claim 6, wherein the first layer of the interconnect includes at least one of a La-ferrite, a Sr-ferrite, a LaSr-ferrite, a Ba-ferrite, a Y-chromite and a La-chromite, doped with at least one dopant selected from the group consisting of Sr, Ca, Mg, Ni, Co, V and Ti.

8. The solid oxide fuel cell of claim 1, wherein the second layer of the interconnect includes at least one of an n-doped Sr-titanate, an n-doped Ca-titanate, an n-doped Ba-titanate and an n-doped Mg-titanate.

9. The solid oxide fuel cell of claim 8, wherein the second layer of the interconnect includes a Sr-titanate or Ca-titanate that is doped with at least one dopant selected from the group consisting of La, Y, Nb, Mn, V, Cr, W, Mo and Si.

10. The solid oxide fuel cell of claim 1, wherein the solid electrolyte includes at least one material selected from the group consisting of ZrO₂ based material, CeO₂ based material and lanthanide-gallate based material.

11. The solid oxide fuel cell of claim 1, wherein the first electrode includes a La-manganate based material.

12. The solid oxide fuel cell of claim 1, wherein the second electrode includes a nickel cermet.

13. The solid oxide fuel cell of claim 1, wherein the thickness of each of the first and second electrodes of at least one of the cells is in a range of between about 1 mm and about 2 mm.

14. The solid oxide fuel cell of claim 13, wherein the thickness of the interconnect is in a range of between about 10 μm and about 1,000 μm.

15. The solid oxide fuel cell of claim 14, wherein the thickness of the interconnect is in a range of between about 10 μm and about 200 μm.

16. The solid oxide fuel cell of claim 15, wherein the thickness of the interconnect is in a range of between about 50 μm and about 150 μm.

17. The solid oxide fuel cell of claim 1, wherein the cells are connected with each other in series.

18. A method of forming a solid oxide fuel cell that includes a plurality of sub-cells, comprising the step of connecting each of the sub-cells with an interconnect, wherein each sub-cell includes:
i) a first electrode in fluid communication with a source of oxygen gas,
ii) a second electrode in fluid communication with a source of a fuel gas, and
iii) a solid electrolyte between the first electrode and the second electrode, and
wherein the interconnect includes:
i) a first layer of at least one material selected from the group consisting of a doped M-ferrite based perovskite, a doped M′-ferrite based perovskite, a doped MM′-ferrite based perovskite and a doped M′-chromite, wherein M is an alkaline earth metal and M′ is a rare earth metal, and wherein the first layer is in contact with the first electrode of each cell; and
ii) a second layer that includes a doped M″-titanate based perovskite, wherein M″ is an alkaline earth metal, and wherein the second layer is in contact with the second electrode of each cell.
